(19) United States
(12) Patent Application Publication
(10) Pub. No.: US 2007/0196642 A1
(43) Pub. Date: Aug. 23, 2007

(54) Coating for biological rejuvenation

(76) Inventors: Michael D. Feldstein, Princeton, NJ (US); Phillip Dumas, Morrisville, PA (US)

Correspondence Address: SURFACE TECHNOLOGY, INC.,, P.O. BOX 8585, TRENTON, NJ, 08650, US

(21) Appl. No.: 11/356,856

(22) Filed: Feb. 17, 2006

(51) Int. Cl. B32B 18/00

(52) U.S. Cl. 428/323; 428/325; 428/330

(57) ABSTRACT

Disclosed is a description of articles with coatings for biological rejuvenation. The coatings include composite coatings with particulate matter within a metallic matrix where the particulate matter promotes biological rejuvenation. Articles with composites coatings incorporating more than one particulate matter and/or more than one coating layer are also disclosed.

### BACKGROUND OF THE INVENTION

The plating of articles with a composite coating bearing finely dispersed divided particulate matter is well documented. This technology has been widely practiced in the field of electroplating as well as electroless plating. The acceptance of such composite coating stems from the recognition that the inclusion of finely divided particulate matter within metallic matrices can significantly alter the properties of the coating with respect to properties such as wear resistance, lubricity, friction, thermal transfer, and appearance.

Electroless composite technology is a more recent development as compared to electrolytic composite technology. The fundamentals of composite electroless plating is documented in a text entitled “Electroless Plating Fundamentals and Applications,” edited by G. Mallory and J. B. Hajdu, Chapter 11, published by American Electroplaters and Surface Finishers Society (1990).

The evolution of composite electroless plating dates back to Oderkerken U.S. Pat. No. 3,644,183 in which a structure of composite electroless plating with finely divided aluminum oxide was interposed between electrodeposited layers to improve the corrosion resistance. Thereafter, Metzger et al, U.S. Pat. Nos. 3,617,363 and 3,753,667 extended the Oderkerken work to a great variety of particles and miscellaneous electroless plating baths. Thereafter, Christini et al in Reissue Patent 33,767 further extended the composite electroless plating to the codeposition of diamond particles. In addition, Christini et al demonstrated certain advantages associated with the deposition of the barrier layer (strike) prior to the composite layer.

Feldstein in U.S. Pat. Nos. 4,358,922 and 4,358,923 demonstrated the advantages of utilizing a metallic layer above the composite layer. The overlayer is essentially free of any particulate matter. Spencer in U.S. Pat. No. 4,547,407 demonstrated the utilizing of a mixture of dual sized particles in achieving improved smoothness of coating.

Feldstein et al in U.S. Pat. Nos. 4,997,686, 5,145,517, 5,300,330, 5,863,616, and 6,306,466 B1 demonstrated utilization of particulate matter stabilizers in the deposition of uniform stable composite electroless plating. Parker in U.S. Pat. No. 3,723,078 demonstrated the codeposition of refractory metals and chromium along with composite electroless plating.

Helle et al in U.S. Pat. Nos. 4,098,654 and 4,302,374 explored special surfactant compositions in the preparation of stabilized PTFE dispersions and their subsequent utilization in electrolytic plating.

Kurosaki et al in U.S. Pat. No. 3,787,294 proposed the use of cationic stabilizers for graphite fluoride be used in electroplating with specific attention focused upon surfactants having a C—F bond in their structure.

Brown et al in U.S. Pat. No. 3,677,907, demonstrated the utilization of surfactants also having a C—F bond in their skeleton used in combination with PTFE electrolytic codeposition.

Henry et al in U.S. Pat. No. 4,830,889, demonstrated the utilization of a cationic fluorocarbon surfactant along with a non-ionic fluorocarbon surfactant for the codeposition of graphite fluoride in electroless plating baths.

Feldstein in U.S. Pat. Nos. 5,514,479, 5,516,591, and 5,834,065 demonstrated the novel inclusion of particles with light emitting properties into composite plated layers to create layers that can emit light for identification and authentication purposes.

Feldstein et al in U.S. Patent No. 5,580,375 also demonstrated the use of “frozen states” to overcome the limited shelf-life associated with certain dispersions before their use in plating applications.

Feldstein in U.S. Pat. No. 6,309,583 demonstrated the ability to enhance the thermal transfer properties of articles coated with various composite coatings.

Feldstein et al in U.S. Pat. No. 6,506,509 demonstrated the ability to and utility of producing composite layers with varying densities of codeposited particles in the plated layer along the surface of the substrate.

The above patents reflect the state of the art and they are included herein by reference.

The above patents as well as the commercial uses of composite plating are limited to coatings with particulate matter that is generally categorized as hard, wear resistant, lubricating, thermal transferring, insulating, frictional, and/or light emitting. In none of the above patents or commercial practice can be found composite plated coatings incorporating particulate matter that promotes biological rejuvenation.

While not wanting to be bound by definition, the term biological rejuvenation is used to refer generally to growth, reproduction, and/or adhesion of biological matter.

This invention relates to articles with coatings where said coatings are composite plated coatings containing materials that promote biological rejuvenation.

A wide variety of methods have been developed over hundreds of years to repair or alter human and animal bodies including methods designed to promote biological rejuvenation in both humans and animals. Examples include but are not limited to bone transplantation, bone and tissue grafting, implants made of metals, alloys, ceramics, and others. Common metals used for such implants are titanium, various stainless steel alloys, aluminum, and others. Such implants range from dental implants, rods, plates, artificial hips, and others. A further field of development has been in surface modification of the implants to increase their acceptance and/or function in the body. One such surface modification is the texturing of the implant's surface to be a more effective site for bone or tissue growth. Various coatings have also been developed for the same purpose for implant devices. Such coatings have been known to include bone or other materials to which new bone growth would be compatible. Also incorporated into such coatings have been substances like drugs, bone morphogenic proteins, or others that promote bone growth. Coating methods have included ceramics, plasma sprays of materials such as titanium, and others.

Nowhere in the prior art have composite plated coatings with biological rejuvenation enhancing materials been disclosed. Nowhere in the prior art have implants of the variety discussed herein been developed with composite plated coatings with biological rejuvenation enhancing materials. It is the object of the present invention to disclose the novelty and utility of articles with composite plated coatings bearing materials that promote biological rejuvenation such as bone and tissue growth.

Composite plated coatings for the purposes disclosed in the present invention would be efficacious for a multitude of reasons including, but not limited to the following discussion.

The Food and Drug Administration of the United States Department of Health and Human Services has reviewed composite plated coatings incorporating a variety of particulate materials. A specific example is that this agency has issued a positive review of four proprietary composite electroless nickel coatings of Surface Technology, Inc. of Trenton, N.J., sold under the trade names of Composite Diamond Coating, NiPlate 700, NiSlip 25, and NiSlip 500 that respectively contain diamond, silicon carbide, boron nitride, and PTFE. It is therefore anticipated that the present invention would be compatible with human and animal usage, as the coatings disclosed are similar in structure to those already positively reviewed with the addition of biologically compatible material in addition to, or instead of another particulate matter.

Composite plated coatings have various properties advantageous for the articles discussed in the present invention. For example, a common electroless nickel-phosphorous alloy that could be used in composite electroless nickel coatings has a melting temperature of about 1600 degrees Fahrenheit, a hardness of about 500 Vickers as plated and a hardness potential of about 950 Vickers with a suitable heat treatment, and adhesion of about 45,000 psi to steel, for example. Adhesion to other materials is also possible and routine. The specific level of adhesion depends on which material and coating process is used. These properties can help make composite electroless nickel plated coatings beneficial for articles such as those disclosed herein where adhesion, wear, and other parameters must be met. Numerous other plated alloys can be utilized as matrices for the present invention including other nickel-phosphorous alloys, nickel-boron alloys, cobalt-phosphorous alloys, cobalt-boron alloys, gold and gold alloys, silver and silver alloys. Development of a titanium or titanium alloy plated coating into which biological rejuvenation enhancing particulate or other material could be incorporated would also be an effective matrix to provide the utility of the present invention. Matrices that do not contain nickel may be of particular interest for such dental and medical applications as some people report a negative reaction to nickel metal.

The texture of composite plated coatings is also a potential advantage to the requirements of the biological rejuvenation applications discussed herein. Certain articles within this field are already produced with a deliberately textured surface to promote enhanced adhesion of bone, tissue, or other materials to the article. The particulate material within such composite plated coatings will protrude to some degree from the surface of such coatings. The degree of protrusion can be modified by selection of particle type and size as well as subsequent surface modification to affect such protrusion. These protruding particles can act as sites around which bone, tissue, or other biological rejuvenation can occur. The present invention is of even greater utility in that protruding particles can facilitate bone, tissue, or other biological rejuvenation due to their composition, as well as their positioning and resulting texture. Included in the scope of this invention, however, is the use of particles within a plated layer on articles where biological rejuvenation is desired even if the particles themselves have no inherent biological rejuvenation properties, but their inclusion in and protrusion from such a coating would promote biological rejuvenation on the surface of said article.

The present invention relates to all varieties of composite plating methods, including but not limited to electroless, electrolytic, immersion, and brush plating. Each method differs in process and resulting properties.

Articles coated with electroless varieties of composite plating also achieve the benefit of a uniform coating thickness of the plated layer on all surfaces of the article regardless of geometry of the article.

In general, devices used in human and animal implantation are quite expensive. Efficacy and reliability are vital for this reason, and more so given the serious medical and mortal significance of such implants.

It is further within the scope of this invention to apply a composite plated coating as portrayed above plus the additional step of applying a secondary overcoat layer comprised of some of or all of the same or other materials as utilized within the initial composite layer. Because of the protrusion of the certain particulate material on the surface of the composite plated layer, the adhesion or bonding of the overcoat layer to the like material in the composite layer may be promoted. This could be used for polymerizing additional materials to the composite plated coating.

### SUMMARY OF THE INVENTION

The present invention is for articles with a coating to promote biological rejuvenation. The coatings included in the present invention are composite plated coatings with particulate matter with bone, tissue or other biological rejuvenation properties including texture. A key benefit of the present invention is the strength, conformity, and adhesion of said coatings to articles. Articles with composites coatings incorporating more than one particulate matter and/or more than one coating layer are also included in the present invention. This would be advantageous and novel since many articles where biological rejuvenation is desired also would benefit from increased wear resistance, lubricity or other properties for ongoing performance in their intended use that can be provided by the incorporation of additional particulate matter into the coating with particles that have biological rejuvenation properties.

### DETAILED DESCRIPTION

The most common methods of plating are electrolytic, electroless (also known as auto-catalytic or chemical plating), and brush. Such conventional plating is commonly used for corrosion protection, aesthetics, wear resistance, and other properties. Composite plating with particulate matter within the plated layer is widely used for hardness, wear resistance, frictional, lubricating, release, and other properties, but nowhere in the prior art have particles been incorporated into plated layers for biological rejuvenation properties. Articles with a composite plated coating incorporating such particles will achieve increased biological rejuvenation. Such composite plated coatings may further serve as an under layer on which subsequent coatings may be applied for increased biological rejuvenation or other properties. Selection of the particulate material to incorporate into the composite plated coatings therefore may also be made to increase adhesion of the subsequent coating. One of the possible means by which this could be achieved is to incorporate into the composite plated coating particles of the same material as forming or included within the subsequent coating.

Articles on which such coatings or combinations of coatings may be beneficial include, but are not limited to, bone implants, rods, plated, wedges, screws, dental implants, etc. Articles may be made of metal or nonmetal materials. Another improvement of the present invention is that the coatings disclosed herein can be applied to metal and nonmetal articles with excellent conformity and adhesion. Steel substrates were used in the examples of the present invention, but aluminum, titanium, stainless steel, and many other metals, alloys, ceramics, and composites of metals and non-metals can be coated by any of the processes covered by the present invention.

Selection of the appropriate plating matrix, particulate material, method of application, and coating specifications will depend on factors related to each application such as use, compatibility, size, geometry, substrate material, and others. As there are a wide variety of such coating combinations, such coatings can be tailored to the requirements of each application.

A wide variety of plating matrices could be used including numerous metals and alloys applied by electroless, electrolytic, and other methods. Incorporated into this plated layer could be a large variety of particulate materials that would promote biological rejuvenation. Examples include bone and tissue particulate, drugs, bone morphogenic proteins, and other materials.

Also included in this invention are articles with combination composite plated coatings incorporating more than one particulate material where at least one if these particulate materials functions to enhance biological rejuvenation. Such combination composite plated coatings will provide enhanced and/or multiple properties and/or synergistic benefits. While not wanting to be bound by theory, one such example may be to include a hard and rough particulate material such as diamond or ceramic to yield a hard or textured surface onto which biological rejuvenation would be compatible in addition to the incorporation of a drug or drug containing material to further enhance biological rejuvenation. Another such example would be to include simultaneously bone particulate and a drug or drug containing material to facilitate biological rejuvenation via multiple properties.

It is also within the scope of this invention to incorporate additional particulate material of other purposes such as hardness, wear resistance, friction, lubricity and others within the coating in addition to the biological rejuvenation enhancing material to provide additional functional properties.

### EXAMPLE 1

A 300-milliliter solution of the electroless nickel-phosphorous plating bath commercially available as NiPlate® 700 from Surface Technology, Inc. of Trenton, N.J. was prepared according to the manufacturer's specifications. To this bath was added 10 grams of hydroxylapatite reagent grade powder. The particles were dispersed in the plating bath for fifteen minutes. The plating bath was then heated to 85 degrees Celsius. A steel panel weighing approximately three grams with a surface area of about 20 square centimeters was cleaned and immersed in the plating bath. After 40 minutes of plating time, the coated panel was removed from the plating bath, rinsed and dried. A cross section of the coated panel was made, and microscopic examination revealed that the coating contained hydroxylapatite particles within the metal matrix.

### EXAMPLE 2

A slurry of 10 grams of bovine bone particles in 100 grams of distilled water was prepared. This slurry was stirred vigorously for one hour. 10 milliliters of this slurry was then added to a 300 milliliter solution of the electroless nickel-phosphorous plating bath commercially available as NiPlate® 700 from Surface Technology, Inc. of Trenton, N.J. was prepared according to the manufacturer's specifications. The plating bath was then heated to 85 degrees Celsius. A steel panel weighing approximately three grams with a surface area of about 20 square centimeters was cleaned and immersed in the plating bath. After 60 minutes of plating time, the coated panel was removed from the plating bath, rinsed and dried. A cross section of the coated panel was made, and microscopic examination revealed that the coating contained bovine bone particles within the metal matrix.

1. An article with a coating formed thereon, said coating consisting essentially of particulate matter within a metal matrix wherein said particulate matter has biological rejuvenation properties.

2. The article according to claim 1 wherein said article is heat treated after said coating is applied.

3. The article according to claim 1 wherein said metal matrix is applied by an electroless plating method.

4. The article according to claim 1 wherein said metal matrix is applied by an electrolytic plating method.

5. The article according to claim 1 wherein said metal matrix contains nickel metal.

6. The article according to claim 1 wherein said metal matrix is electroless nickel-phosphorous.

7. The article according to claim 1 wherein said metal matrix is electroless nickel-boron.

8. The article according to claim 1 wherein said metal matrix is selected from a group consisting of nickel-phosphorous-tungsten, cobalt, cobalt-phosphorous, cobalt-boron, gold, gold alloys, silver, silver alloys, titanium, and titanium alloys.

9. The article according to claim 1 wherein said coating also contains particulate matter that is not primarily characterized with biological rejuvenation properties.

10. The article according to claim 1 wherein said coating also contains particulate matter that is wear resistant.

11. The article according to claim 1 wherein said coating also contains particulate matter that is lubricious.

12. The article according to claim 1 wherein said coating also contains particulate matter that contains diamond.

13. The article according to claim 1 wherein said coating contains more than one particulate matter with biological rejuvenation properties.

14. The article according to claim 1 where one or more subsequent coatings is applied to said coating.

15. The article according to claim 1 wherein said particulate matter promotes the adhesion of subsequent materials or coatings to said coating.

16. The article according to claim 1 where said article is selected from a group consisting of steel, stainless steel, titanium, monel, nickel, aluminum, ceramic, and combinations thereof.

17. The article according to claim 1 where said article is selected from a group consisting of dental implants, rods, plates, wedges, screws, artificial body parts.

18. The article according to claim 1 where said coating is subsequently altered to affect the degree of protrusion of said particulate matter from said metal matrix.

19. The article according to claim 1 where said article is subsequently implanted into a human body.

20. The article according to claim 1 where said article is subsequently implanted into an animal body.
